(19) United States
(12) Patent Application Publication
(10) Pub. No.: US 2017/0257664 A1
(43) Pub. Date: Sep. 7, 2017

(54) METHOD, ELECTRONIC DEVICE, AND SYSTEM FOR IMMERSIVE EXPERIENCE

(71) Applicant: Telefonaktiebolaget LM Ericsson (publ)

(72) Inventors: Kwan To TAM, Shanghai (CN); Leijun YANG, Shanghai (CN); Xiaoli TONG, Shanghai (CN)

(21) Appl. No.: 14/910,779

(22) PCT Filed: Feb. 2, 2016
(86) PCT No.: PCT/CN2016/073189

§ 371 Date: Feb. 8, 2016

(51) Int. Cl. H04N 21/436; H04N 21/44; H04N 21/6332; H04N 21/435

(52) U.S. Cl. CPC H04N 21/436; H04N 21/435; H04N 21/44; H04N 21/6332

(57) ABSTRACT

The present disclosure proposes a system, a method, and electronic devices for providing a user with immersive experience comprising special effects (SFX) during playback of a media stream. The system may comprise a content delivery server, an IoT gateway, and at least one IoT device. The content delivery server transmits the media stream comprising an SFX instruction. The IoT gateway monitors the media stream from the content delivery server; determine the SFX instruction from the media stream; determine, according to the SFX instruction, at least one IoT device which is able to provide at least one special effect corresponding to the SFX instruction; and transmit to the at least one IoT device an IoT device specific command corresponding to the SFX instruction. The at least one IoT device receives the IoT device specific command from the IoT gateway; and provide the special effect according to the command.

### TECHNICAL FIELD

The present disclosure generally relates to the field of media playback, and in particular, to a method, an electronic device, and a system for providing a user with immersive experience comprising various special effects (SFX) during playback of a media stream.

### BACKGROUND

Traditionally, digital entertainment is all about delivering content to a picture display device (e.g. a TV) together with audio to a certain sound system (e.g. speakers embedded into the TV or an external audio system). Today's IPTV services offer content over IP networks to TVs and smart devices, plus some add-on functionalities such as Electronic Program Guide (EPG), social networking, program recording, etc. There is not much differentiation among competitions of these service offerings and the content is always delivered to devices with a display capable of a certain color, audio and resolution requirements that resemble to a traditional TV display.

With over 50 billion connected devices and the 5G network, our surrounding environment will be more or less connected, for example, Internet of Things (IoT). With those connected things that are under our control and management, many new opportunities could exist to enhance or improve our entertainment experience and bring benefit to the whole content delivery chain from content production to consumption.

### SUMMARY

Our TV viewing experience is not only from the screen and the audio systems, but also from the surrounding environment of the viewer. In fact, what is in our immediate surroundings also constitutes an important part of the whole TV viewing experience, such as the lightings, temperature, or even the events happening during the program or movie watching. As a common example, some viewers may dim the light when viewing a horror movie, or close their room doors and windows to shut out any external noise when viewing a music concert. However, such actions are not sufficient to provide the user with a highly immersive experience during playback of the media session.

In fact, content producers have spent a lot of efforts to perfect SFXs shown in a movie including the lighting and audio effects. However, The existing IPTV services do not care about nor have control over these environmental factors, thus may not be able to enhance further the end user's experience when consuming a certain multimedia content, such as a sci-fi movie or a horror show with many well designed SFXs.

It is in view of the above considerations and others that the various embodiments of the present disclosure have been made. To be specific, aiming to at least some of the above defects, the present disclosure proposes a system, a method, and electronic devices for providing a user with immersive experience comprising special effects (SFX) during playback of a media stream at a low cost.

According to a first aspect of the present disclosure, a system for providing Special Effect (SFX) during a media stream is provided. The system may comprise a content delivery server, an IoT gateway, and at least one IoT device. The content delivery server is adapted to transmit the media stream comprising an SFX instruction. The IoT gateway is adapted to monitor the media stream from the content delivery server; determine the SFX instruction from the media stream; determine, according to the SFX instruction, at least one IoT device which is able to provide at least one special effect corresponding to the SFX instruction; and transmit to the at least one IoT device an IoT device specific command corresponding to the SFX instruction. The at least one IoT device is adapted to receive the IoT device specific command from the IoT gateway; and provide the special effect according to the command.

According to a second aspect of the present disclosure, a method, performed by an Internet of Things (IoT) gateway, for controlling at least one IoT device is provided. The method may comprise: determining a Special Effect (SFX) instruction from a media stream; determining, according to the SFX instruction, at least one IoT device which is able to provide at least one special effect corresponding to the SFX instruction; and transmitting to the at least one IoT device an IoT device specific command corresponding to the SFX instruction.

Preferably, the SFX instruction may be coded into the media stream as a track, and the determination of the SFX instruction may comprise: extracting the coded SFX instruction track from the media stream; and decoding the SFX instruction from the coded SFX instruction track. Alternatively, the SFX instruction may be determined by an algorithm for determining control parameters from media content in the media stream. Preferably, the SFX instruction may comprise at least one of: action, action parameter, time for action, duration of action, capability, and location. Preferably, the at least one IoT device may be pre-registered in a registration list at the IoT gateway, and the determination of at least one IoT device which is able to provide at least one special effect may comprise: searching, according to the SFX instruction, the registration list for the at least one IoT device which is able to provide at least one special effect corresponding to the SFX instruction.

Preferably, the at least one IoT device may comprise at least one of: a home appliance, a computer, and a haptic feedback device. Preferably, the home appliance may comprise at least one of: a TV, an audio system, an air conditioner, a heater, and a light. Preferably, the haptic feedback device may comprise a haptic/actuated garment, an electronic bracelet, a furniture with haptic feedback capabilities. Preferably, the haptic/actuated garment may comprise at least one of haptic/actuated gloves and shoes, and the furniture with haptic feedback capabilities comprises at least one of a chair and a sofa.

Preferably, the transmission of the IoT device specific command may comprise: determining, based on the SFX instruction, the IoT device specific command from a translation table which is specific to the at least one IoT device; and transmitting the IoT device specific command to the at least one IoT device. Preferably, the IoT device specific command may be transmitted to the at least one IoT device by the IoT gateway before the time for action and the at least one IoT device will perform the action at the time for action. Preferably, the IoT device specific command may be transmitted to the at least one IoT device by the IoT gateway at the time for action and the at least one IoT device will perform the action immediately. Preferably, the method may further comprise: receiving from the at least one IoT device a command execution result in response to the IoT device specific command. Preferably, the method may further comprise: receiving information about user intervention from the at least one IoT device. Preferably, the method may further comprise: transmitting feedback comprising the command execution result and/or the information about user intervention to a content delivery server.

According to a third aspect of the present disclosure, an electronic device for controlling at least one IoT device is provided. The electronic device may be adapted to: determine a Special Effect (SFX) instruction from a media stream; determine, according to the SFX instruction, at least one IoT device which is able to provide at least one special effect corresponding to the SFX instruction; and transmit to the at least one IoT device an IoT device specific command corresponding to the SFX instruction.

According to a fourth aspect of the present disclosure, an electronic device for controlling at least one IoT device is provided. The electronic device may comprise: a processor; and a memory containing instructions which, when executed by the processor, causes the processor to: determine a Special Effect (SFX) instruction from a media stream; determine, according to the SFX instruction, at least one IoT device which is able to provide at least one special effect corresponding to the SFX instruction; and transmit to the at least one IoT device an IoT device specific command corresponding to the SFX instruction.

Preferably, the SFX instruction may be coded into the media stream as a track, and the processor may be further configured to: extract the coded SFX instruction track from the media stream; and decode the SFX instruction from the coded SFX instruction track. Alternatively, the processor may be further configured to determine the SFX instruction by an algorithm for determining control parameters from media content in the media stream. Preferably, the SFX instruction may comprise at least one of: action, action parameter, time for action, duration of action, capability, and location. Preferably, the at least one IoT device may be pre-registered in a registration list at the IoT gateway, and the processor may be further configured to: search, according to the SFX instruction, the registration list for the at least one IoT device which is able to provide at least one special effect corresponding to the SFX instruction.

Preferably, the at least one IoT device may comprise at least one of: a home appliance, a computer, and a haptic feedback device. Preferably, the home appliance may comprise at least one of: a TV, an audio system, an air conditioner, a heater, and a light. Preferably, the haptic feedback device may comprise a haptic/actuated garment, an electronic bracelet, a furniture with haptic feedback capabilities. Preferably, the haptic/actuated garment may comprise at least one of haptic/actuated gloves and shoes, and the furniture with haptic feedback capabilities comprises at least one of a chair and a sofa.

Preferably, the processor may be further configured to: determine, based on the SFX instruction, the IoT device specific command from a translation table which is specific to the at least one IoT device; and transmit the IoT device specific command to the at least one IoT device. Preferably the IoT device specific command may be transmitted to the at least one IoT device by the IoT gateway before the time for action and the at least one IoT device will perform the action at the time for action. Preferably, the IoT device specific command may be transmitted to the at least one IoT device by the IoT gateway at the time for action and the at least one IoT device will perform the action immediately. Preferably, the processor may be further configured to: receive from the at least one IoT device a command execution result in response to the IoT device specific command. Preferably, the processor may be further configured to: receive information about user intervention from the at least one IoT device. Preferably, the processor may be further configured to: transmit feedback comprising the command execution result and/or the information about user intervention to a content delivery server.

According to a fifth aspect of the present disclosure, a computer program which, when executed by a processor, causes the processor to perform any of the methods according to the second aspect of the present disclosure is provided.

According to a sixth aspect of the present disclosure, a computer program product comprising a computer program according to the fifth aspect is provided.

According to a seventh aspect of the present disclosure, an apparatus, implemented at an electronic device, for controlling at least one IoT device is provided. The apparatus may comprise: means for determining a Special Effect (SFX) instruction from a media stream; means for determining, according to the SFX instruction, at least one IoT device which is able to provide at least one special effect corresponding to the SFX instruction; and means for transmitting to the at least one IoT device an IoT device specific command corresponding to the SFX instruction.

According to an eighth aspect of the present disclosure, a method, performed by an Internet of Things (IoT) device, for providing a Special Effect (SFX) is provided. The method may comprise: receiving an IoT device specific command corresponding to an SFX instruction which is determined from a media stream; and executing the IoT device specific command to provide the SFX.

Preferably, the IoT device may be pre-registered in a registration list at an IoT gateway. Preferably, the method may further comprise: transmitting to an IoT gateway a command execution result in response to the IoT device specific command. Preferably, the method may further comprise: transmitting information about user intervention to an IoT gateway. Preferably, the IoT device maintains its SFX-related information comprising one or more of: device ID, device type, device location, resource availability, resource permission, and resource capability. Preferably, the method may further comprise: reporting the SFX-related information to an IoT gateway.

According to a ninth aspect of the present disclosure, an electronic device for providing a Special Effect (SFX) is provided. The electronic device may be adapted to: receive an IoT device specific command corresponding to an SFX instruction which is determined from a media stream; and execute the IoT device specific command to provide the SFX.

According to a tenth aspect of the present disclosure, an electronic device for providing a Special Effect (SFX) is provided. The electronic device may comprise: a processor; and a memory containing instructions which, when executed by the processor, causes the processor to: receive an IoT device specific command corresponding to an SFX instruction which is determined from a media stream; and execute the IoT device specific command to provide the SFX.

Preferably, the processor may be further configured to pre-register in a registration list at an IoT gateway. Preferably, the processor may be further configured to: transmit to an IoT gateway a command execution result in response to the IoT device specific command. Preferably, the processor may be further configured to: transmit information about user intervention to an IoT gateway. Preferably, the processor may be further configured to maintain its SFX-related information comprising one or more of: device ID, device type, device location, resource availability, resource permission, and resource capability. Preferably, the processor may be further configured to: report the SFX-related information to an IoT gateway.

According to an eleventh aspect of the present disclosure, a computer program which, when executed by a processor, causes the processor to perform any of the methods of the eighth aspect of the present disclosure is provided.

According to an twelfth aspect of the present disclosure, a computer program product comprising a computer program of the eleventh aspect of the present disclosure is provided.

According to an thirteenth aspect of the present disclosure, an apparatus, implemented at an electronic device, for providing a Special Effect (SFX) is provided. The apparatus may comprise: means for receiving an IoT device specific command corresponding to an SFX instruction which is determined from a media stream; and means for executing the IoT device specific command to provide the SFX.

With the above method, electronic devices, and/or system, it will bring into consumer's surroundings to become part of the media content delivered from the Multimedia Content Delivery Services. Business models can also be built upon offering to this new ability to leverage the audience's IoT devices to be used for SFX for better entertainment experience. The knowledge gained via interacting with these IoT devices would also contribute to a part of the big-data business.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a diagram showing an exemplary system for providing users with immersive experience comprising various SFXs during playback of a media stream according to an embodiment of the present disclosure.

FIG. 2 is a diagram showing a message flow among various entities in the system shown in FIG. 1.

FIG. 3 is a diagram showing an exemplary application scenario according to an embodiment of the present disclosure.

FIG. 4 is a flow chart showing a method performed at an Internet of Things (IoT) gateway for controlling at least one IoT device according to an embodiment of the present disclosure.

FIG. 5 is a block diagram schematically showing an exemplary arrangement which may be used in an IoT gateway according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Further, as used herein, the term “user” may refer to not only a human user, but also a non-human user, such as a computer or any device that receives a request and respond to the request, for example.

In general, the present disclosure proposes a solution to connect Multimedia Content Delivery Services to IoT devices for providing a richer viewing experience for a certain type of SFXs to become Extended-SFX (eSFX). By connecting a Multimedia Content Delivery Service to IoT devices, it allows these IoT devices around the audience's immediate surroundings to be used as part of the SFX in the multimedia content such as a Movie. These Multimedia Content Delivery Services can be IPTV (such as MediaFirst), OTT video (Over The Top video, such as Netflix), UGC (User Generated Content, such as YouTube), or any kind of service that delivers multimedia content to the end users.

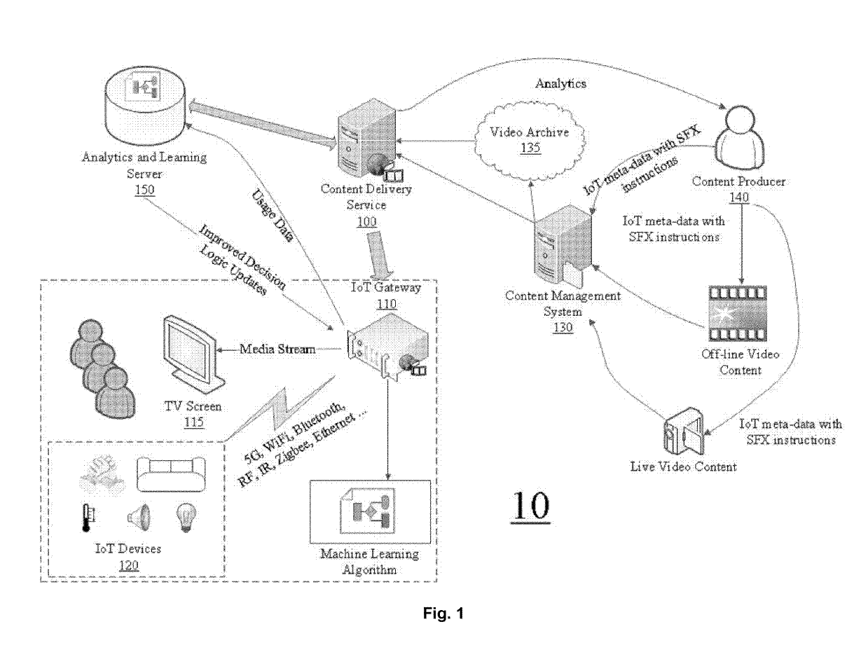

FIG. 1 is a diagram showing an exemplary system 10 for delivering eSFXs to users' vicinity and collecting feedbacks for fine-tuning and preferences according to an embodiment of the present disclosure.

As shown in FIG. 1, the system 10 may comprise a server 100 providing a multimedia Content Delivery Service (CDS), an IoT gateway 110 that handles and manages one or more IoT devices 120 and the connectivity with the multimedia CDS 100, and the one or more IoT devices 120 in the immediate surroundings that are under the management of the IoT gateway 110 or are able to interact with the IoT gateway 110. Further, the system 10 may optionally comprise a Content Management System (CMS) 130, a video archive 135, and an analytics and learning server 150.

As shown in FIG. 1, one or more content producers 140 may process media content, such as off-line video content (a movie, for example), live video content (broadcasting of a sport event, for example), or any other media stream, to add IoT meta-data with SFX instructions into the media stream at the CMS 130. The resulting media stream with the SFX instructions embedded therein can be passed by The CMS 130 to the CDS 100 for further delivering to end users, and/or to the video archive 135 for storage.

Further, in an alternative embodiment, the IoT meta-data with SFX instructions may not be embedded into the media stream and stored into the video archive 135 together with the media stream. Instead, upon a request from CDS 100 or the video archive 135, the CMS 130 may provide the CDS 100 with the IoT meta-data having SFX instructions together with the media stream provided from the video archive 135 in a synchronized manner. In this way, the CDS 100 may also provide the media stream and the IoT meta-data to the IoT gateway 110 simultaneously.

Either way, when the CDS 100 is delivering a certain piece of content to end users, the IoT meta-data is also delivered to the same location and can be detected and extracted by the IoT gateway 110.

With the extracted IoT meta-data, the IoT gateway 110 then interprets the SFX instructions embedded therein and compare to the current environment to determine if one or more certain criteria have been met for these instructions to carry out. If so, commands will be dispatched to these selected IoT devices 120 to produce the desired SFXs such as playing a sound, turn off the lights, etc.

As shown by FIG. 1, the IoT gateway 110 acts as a central communication hub that facilitates the communication between the CDS 100 and the IoT devices 120. In the context of the present disclosure, an IoT gateway is defined as the logic that manages and controls one or more IoT devices 120 with access to the multimedia content and has the ability to translate or transform between IoT meta-data and the corresponding messages to/from the IoT devices 120.

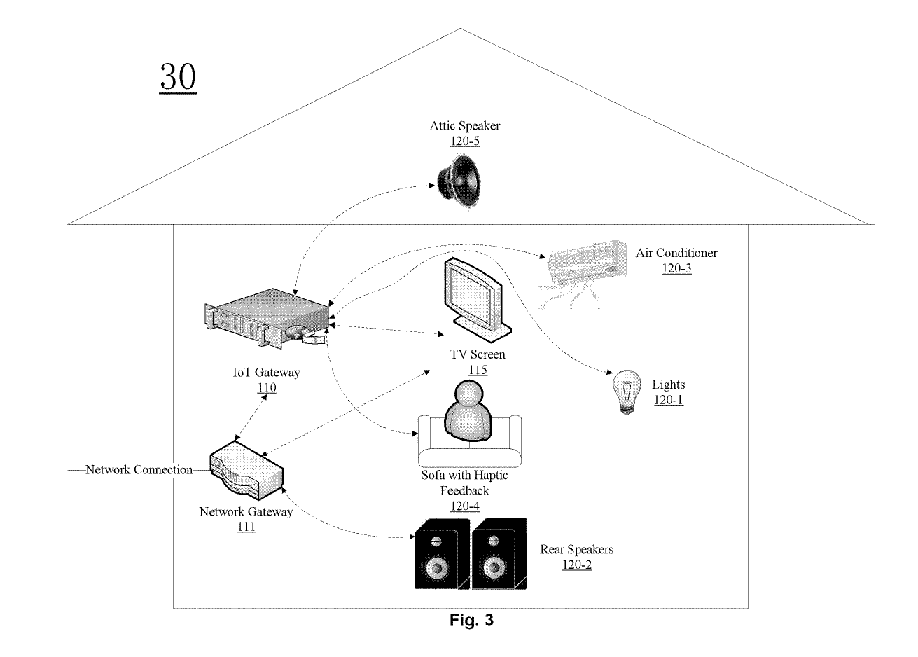

Although it is shown in FIG. 1 that the IoT gateway 110 acts as a central communication hub or a network access device, the present disclosure is not limited thereto. In an alternative embodiment, the IoT gateway 110 may be an electronic device other than a network access device, and there is another device, such as a cable modem, a DSL modem, an FTTH terminal, which acts as a central communication hub. In this case, the media stream with the SFX instructions embedded therein may be broadcast or multicast to several devices including a TV screen 115 and the IoT gateway 110. In other words, the video and/or audio streams may not be transmitted from the IoT gateway 110 to the TV screen 115 as shown in FIG. 1 since the IoT gateway 110 is not responsible for data distribution in this case. More details for this scenario may be given below with reference to the description of FIG. 3.

Further, although it is shown in FIG. 1 that the IoT gateway 110 is located close to the users and/or the IoT devices 120, in some other embodiments, the IoT gateway 110 needs not to be local. With the support of 5G network, the IoT gateway 110 could well sit on the Cloud. For example, the IoT gateway 110 may sit at any place along the path from the CDS 100 to the IoT devices 120. A local presence, if needed, could be in the form of a proxy (surrogate).

Furthermore, although it is shown in FIG. 1 that the IoT gateway 110 is a physical, standalone device, the present disclosure is not limited thereto. For example, the IoT gateway 110 may be a software application residing in another device, such as the TV screen 115, a computer, a set top box, or the like. In other words, the IoT gateway 110 may be implemented in software, hardware, firmware, or any combination thereof as long as similar functionalities can be implemented.

Referring back to FIG. 1, as the SFX instructions, special coded messages in the multimedia content such as a TV program or a movie will be captured and decoded by the IoT gateway 110, and translated by the IoT gateway 110 into corresponding signals that are necessary to communicate, drive and control the IoT devices 120. More details will be explained below.

Further, TV programs or movies or other multimedia content without these special coded messages could still be analyzed by an automatic algorithm to determine the various control parameters that the IoT gateway 110 could make use of to communicate, drive, and control these IoT devices 120.

To be more specific, in an embodiment, if the content media does not come with any of these coded messages that contain the SFX instructions, it is still possible to post-generate these SFX instructions. These SFX instructions will then be able to be interpreted by the IoT gateway 110 in the same way as they were obtained from the multi-media content stream.

For example, one way of producing these SFX instructions automatically is to analyze the video pictures frame by frame and extract the relationship between the overall picture color, local color variations, and the time-position of the frame in the video. The objective is to identify:
A) The color of the light resulted by averaging the whole picture. This will be corresponding to the color illuminated by the TV set when being watched in a darkened room. Suitably using this color would enhance the environmental feeling. For example a flickering yellowish green illumination reflects walking under a green forest in mid-day.
B) The highlight color that will be interested to provide eSFX to enhance the special effects on screen. This is usually stochastic and lasts only a short period of time. It will be corresponding to, for example, the gun shot scenes in the dark, an explosion, or the firing of a beam weapon, etc.

In this way, even with the media stream having no SFX instruction embedded therein, the IoT gateway 110 is still able to provide the viewer with a richer media experience than the existing solutions.

The coded messages (pre-built, post generated, or a combination thereof) can be expressed in any electronic format in plain text, binary, or encrypted, essentially contains one or more of the following information:
Time for Action: When this SFX instruction shall be executed, as according to the video's time reference in SMPTE (Society of Motion Picture and Television Engineers) time code
Duration of Action: How long this SFX instruction shall last
Capability: Specify the capability required for the IoT device 120 to deliver this SFX. A weighting value can be used to indicate the preference, e.g. 10 is most preferred, and 0 means reject, do not use.
Location: The 3-dimensional geographic location of the SFX. It would be a reference to a specific pre-defined coordination system that the software within the IoT gateway pre-agreed with the content provider. It is used by the IoT gateway to determine which IoT device is most suitable for re-producing this SFX given there are multiple of them available in different physical locations around the viewer.
Action: The SFX instruction
Action Parameters: The parameters for this SFX instruction

For example, if the eSFX demands some red flashes that are emitted from an IoT device close to the location (22, 30, 48.5) and that lasts for 3 frames during a laser shooting scene at 00:20:14.22 in a Sci-Fi movie, the coded message could contains something like this:
Time for action: 00:20:14:22
Duration of action: 0.03
Capability: FULLCOLORLIGHT:10, BRIGHTNESS:1, ONOFF:0
Location: 22, 30, 48.5
Action: ON
Action Parameters: ColorRGB 255,20,20

Please note that it is not necessary for the coded message to include all of the above fields. For example, the field “Location” may be set as “any” to indicate that the location could be anywhere, or simply omitted to indicate that the IoT gateway 110 should not care about the locations of the IoT devices 120.

In this non-limiting embodiment, such coded messages can be added into a media stream as one or more standalone tracks which are separated from the video tracks, the audio tracks, the subtitle tracks. Preferably, since the IoT gateway 100 is capable of detecting capabilities of all supported IoT devices and translating the SFX instructions into device specific SFX commands, one SFX instruction track may be sufficient for driving and controlling all different IoT devices 120.

Once the IoT gateway 110 extracts this coded message (or track) from the media stream, it will then look for one or more appropriate IoT devices 120, for example, that are located in the immediate surroundings of the TV screen 115 at which the end users are watching.

In the embodiment shown by FIG. 1, in order to identify the kind of IoT devices 120 that the IoT gateway 110 can be used for a certain SFX as desired by the content producer 140, the knowledge about the capabilities of these devices 120 may be seek beforehand.

The IoT devices 120 shown in FIG. 1 may comprise a pair of tactile gloves, a sofa with haptic feedback capability, a device that can adjust the room temperature (for example, an air conditioner or a heater), a sound system, and a light. However, the IoT devices 120 are not limited thereto, and may comprise but not limited to at least one of: a home appliance, a computer, and a haptic feedback device. To be more specific, the home appliance may comprise but not limited to a TV, an audio system, an air conditioner, a heater, a washing machine, an electronic oven, an air cleaner, a refrigerator, a vacuum cleaning robot, and/or a light, or the like. Further, the haptic feedback device may comprise but not limited to a haptic/actuated garment (such as, gloves, shoes, a jacket, a cap, or the like), an electronic bracelet or necklace or tattoo, furniture with haptic feedback capabilities (such as, a chair, a desk, a sofa, or the like).

These IoT devices 120 may be connected to the IoT gateway 110 in a wired or wireless manner. For example, the IoT devices 120 may be connected to the IoT gateway 110 via 5G, Wi-Fi, Bluetooth, RF (radio frequency), IR (Infrared), Zigbee, or any other wireless technology. Further, the IoT devices 120 may also be connected to the IoT gateway 110 via Ethernet, IEEE 1394, USB, or any other wired technology.

In a specific example of the embodiment, if an IoT device 120 is using Bluetooth Low Energy, the Generic Attributes (GATT) Profile which describes a certain operation characteristics of the device as well as the permissions related to security, when properly configured in a pre-agreed way (for example: https://www.bluetooth.com/specifications/adopted-specifications#gattprofile), should be able to provide enough information to the IoT gateway 110 about the capability and behavior of the IoT devices 120.

For other communications that does not use Bluetooth or GATT, a process known as Device Capability Discovery may be conducted. There is no industrial agreed way for such discovery process to happen across different communication protocols. A simple and effective way to perform this is for the IoT gateway 110 to request a capability file in the form of either a XML or a JSON file. Within this capability file, the information could contain the followings:
Device ID: A globally unique ID for the IoT device 120
Device type: The type of IoT device 120. For example, sensor, switch, audio, control, gateway, etc.
Device Location: The location of the IoT device 120. For example, Attic, Living Room, etc.
Resource available: The kind of resources available from this IoT device 120. For example: Analog output, On/Off toggle, digital input, etc.
Resource permission: The permission of a resource. For example, write only, read/write, write once, subscription, etc.
Resource capability: The capability of a resource. For example: Brightness Integer(0 . . . 255), Color[R,G,B] Integer(0 . . . 255), Volume dB Float(−20.0 . . . +3.0), etc.

An example of the XML file describing the capability of a Philips Hue light bulb could be as follows:

<XML>
<DeviceID>1234</DeviceID>
<DeviceName>Philips Hue</DeviceName>
<DeviceLocation>Living Room</DeviceLocation>
<DeviceType>

<type>switch

<ResourceAvailable>toggle</ResourceAvailable>
<ResourcePermission>Read/Write</ResourcePermission>
<ResourceCapability>Brightness
Integer(0..1)</ResourceCapability>

</type>
<type>Control

<ResourceAvailable>AnalogInput</ResourceAvailable>
<ResourcePermission>Read/Write</ResourcePermission>
<ResourceCapability>FullColorLight [R,G,B]
Integer(0..255,0..255,0..255)</ResourceCapability>

</type>

</DeviceType>
</XML>

This XML file could be embedded into the IoT device 120 and presented passively upon request by the IoT gateway 110 or actively upon registration with the IoT gateway 110. The IoT gateway 110 may maintain a list of locally discovered IoT devices 120, for example, by broadcasting query messages to all local connectable IoT devices 120. To be more specific, the IoT gateway 110 may periodically broadcast query messages for all kinds of IoT devices that it supports to detect whether there is any IoT device 120, and if yes, retrieve its capability information. Further, an IoT device 120 may also actively register with the IoT gateway 110 and provide the IoT gateway 110 with its capability information.

In this way, the IoT gateway 110 may search the list for an IoT device 120 which is able to provide an SFX as required by the SFX instructions embedded in the media stream. In the above example of red flashes, suppose it finds one, for example, a Phillips Hue, then the IoT gateway 110 will look up in a pre-configured translation table for the Phillips Hue to translate the Action (ON/OFF) and Parameters (ColorRGB 255,20,20) to an appropriate command that the Phillips Hue will understand. In other words, the translation table is device specific and there may be many different tables for different types of IoT devices 120, respectively.

Once the commands are formulated, the IoT gateway 110 will issue them as according to the instructions (time for action, duration, etc.). There are at least two ways for the IoT gateway 110 to issue the IoT device specific commands to the IoT devices 120. The first one is to issue the command right before or exactly at the time specified by the “Time for Action” field. In this case, the IoT devices 120 which receive the commands will provide the required SFXs immediately without any delay.

The second one is to issue the command well before the time specified by the “Time for Action” field if the IoT devices 120 support a time-delayed mode in which an SFX may be provided at a specified time. In this way, the IoT gateway 110 may issue the command immediately rather than at the time specified by the “Time for Action” field. More generally, the time range for the IoT gateway 110 to issue the command is from the time it finds the target IoT device 120 to the time specified by the “Time for Action” field.

When the IoT devices 120 receive the commands sent from the IoT gateway 110, they may act according to the commands, respectively, to provide corresponding SFXs.

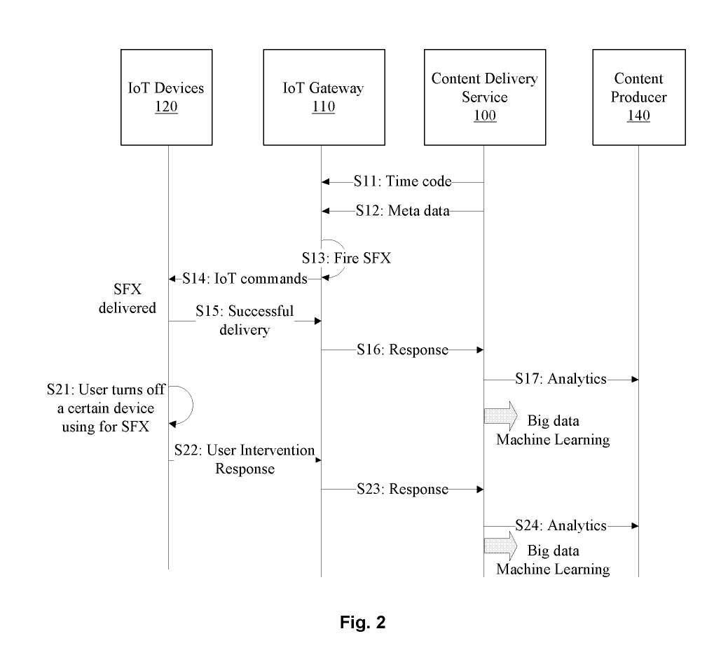

FIG. 2 is a diagram showing a message flow among various entities in the system 10 shown by FIG. 1. As shown in FIG. 2, the interactions among the IoT devices 120, the IoT gateway 110, the CDS 100, and the Content Producer 140 are listed.

At steps S11 and S12, SFX instructions are coded into the multimedia content, for example, as one or more SFX instruction tracks, and are delivered together with the content stream. The IoT meta-data is detected and extracted by the IoT gateway 110 and in turns translated into specific commands for the IoT devices 120 at step S13. Once the condition matched, some of these commands will be transmitted to the IoT devices 120 at step S14 to deliver the SFX as per instruction.

Further, as shown by the steps S15 through S17, the success (or failure) of these deliveries to the IoT devices 120 will be transmitted back to the CDS 100 for further analysis. Analytics can be provided to the Content Producer 140 as a value added service to fine tune the SFXs in the same content or in the future releases.

Further, if the end user decided not to have a certain SFX delivered at step S21, such as by tuning off all full color lights or through other means of not choosing these particular SFX, these decisions are also feedback to the CDS 100 for use with user preferences, big-data or for machine learning for further optimized delivery at steps S22-S24.

If there is any action taken by the end user to alter these SFX, for example, by switching off a certain lights that are supposed to give the SFX, these actions will be recorded by IoT gateway 110 and then the CDS 100 and passed to the big-data analytic engine and machine learning (for example, the analytics and learning server 150 shown in FIG. 1) for analysis of such behavior. Some of these analytics can be made available to the Content Producer 140 as a kind of valuable feedback to fine tune a certain SFX as shown by FIG. 1 and FIG. 2. The end user could also optionally opt out a certain IoT device 120 to exclude in these SFX use via the IoT gateway 110 and/or the CDS 100.

Therefore, by leveraging the 5G network, IoT devices, and one or more IoT gateways, some special effects in the multimedia content can be extended to the physical location of the viewer, enhancing the viewing experience. Further, analytics can be obtained via the user's interaction with these IoT devices and presented as a value added service to the Content Producers who produce the original Special Effects as a reference to future productions or adjustment to the existing content.

FIG. 3 is a diagram showing an exemplary application scenario 300 according to an embodiment of the present disclosure. In the embodiment shown by FIG. 3, the user is going to watch a horror movie at home, and the present disclosure is obviously not limited thereto. The home entertainment system 30 shown by FIG. 3 may comprise a network gateway 111, an IoT gateway 110, a TV screen 115, one or more IoT devices 120 comprising but not limited to one or more lights 120-1, a pair of rear speakers 120-2, an air conditioner 120-3, a sofa with haptic feedback 120-4, and an auxiliary (or attic) speaker 120-5.

As can be seen from FIG. 3, the IoT gateway 110 is not a central communication hub of the system 30, which is different from that of FIG. 1. In the embodiment of FIG. 3, the media stream is transmitted from outside to the network gateway 111, and then broadcast or multicast to the IoT gateway 110 and the TV screen 115. The TV screen 115 may be a conventional digital TV and play the horror movie as usual. On the other hand, the IoT gateway 110 extracts the SFX instructions from the broadcast media stream, for example, as described above with reference to FIG. 1 and FIG. 2. Then the IoT gateway 110 may communicate with the TV screen 115 for synchronization. After the synchronization, the IoT gateway 110 is able to issue the SFX commands to the IoT devices 120, respectively, at a proper timing, according to the SFX instructions. The synchronization can be achieved by many known methods in the art and the description thereof is thus omitted for simplicity.

Further, as shown by FIG. 3, the IoT devices 120 are connected to the IoT gateway 110 directly or indirectly. For example, the lights 120-1, the air conditioner 120-3, the sofa 120-4, and the attic speaker 120-5 are connected to the IoT gateway 110 directly in a wired or wireless manner (for example, via Bluetooth), and the rear speakers 120-2 are connected to the IoT gateway 110 by means of the network gateway 111.

In the embodiment of FIG. 3, the instructions given by the content producer 140 may be that at a certain scene when a ghost in a haunted house starts acting, an audio system (for example, the speaker 120-5) in the user's attic, away from the user's immediate vicinity, will start playing a certain sound effect (like the sound of banging a door, some boxes falling down, etc.), a whisper will come from behind (for example, by the rear speakers 120-2), the sofa 120-4 will start trembling like someone or something heavy walking on the floor, the air temperature will fall somewhat (for example, by the air conditioner 120-3), and/or light in the house starts flickering (for example, by the lights 120-1), giving the whole experience of inside a haunted house, right where the user is watching the movie.

Such a system may provide the user with a highly immersive experience during the playback of the horror movie at a lower cost since all devices involved, except for the IoT gateway 110, are commonly used home appliances.

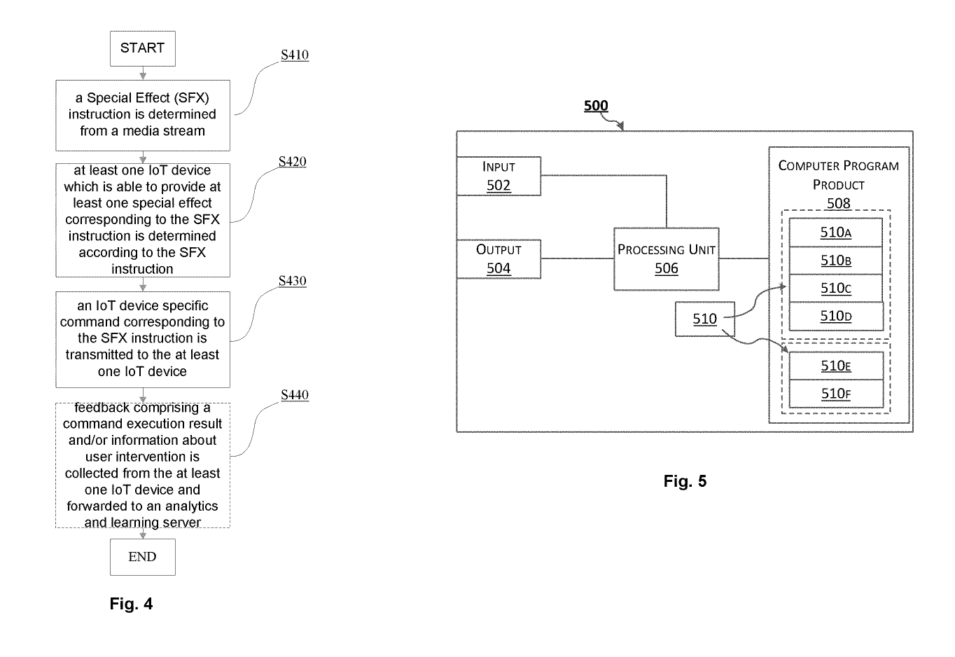

Next, a method 400 performed by the IoT gateway 110 for controlling at least one IoT device 120 will be described with reference to FIG. 4. As shown in FIG. 4, the method 400 begins with the step S410 where an SFX instruction is determined from a media stream. As mentioned above, such an SFX instruction may be embedded into the media stream as a standalone track and can be detected and extracted by the IoT gateway 110.

At the step S420, at least one IoT device 120 which is able to provide at least one special effect corresponding to the SFX instruction is determined according to the SFX instruction. At this step, the IoT gateway 110 may search the list it maintains for any IoT devices 120 that is able to provide the desired SFXs as required by the SFX instruction. For example, the IoT gateway 110 may maintain the list by periodically broadcasting a discover message and receiving response messages for one or more IoT devices 120, and then the IoT gateway 110 may match the requirements from the SFX instruction with the capabilities of the IoT devices 120 on its list to determine whether such an SFX instruction can be handled by its maintained IoT devices 120 or not.

Subsequently, at the step S430, an IoT device specific command corresponding to the SFX instruction is transmitted to the at least one IoT device 120. At this step, with the found IoT devices 120 which are able to provide the desired SFXs, the IoT gateway 110 may then translate the SFX instruction to an IoT device specific command that can be understand and executed by the found IoT device 120, for example, by means of one or more pre-stored translation tables specific to different types of the IoT devices 120, respectively. After that, such a device specific command may be transmitted to the IoT device 120 to trigger the provision of the desired SFX.

Further, the method 400 may further comprise an optional step S440 shown as a dashed block in FIG. 4. At the step S440, feedback comprising a command execution result and/or information about user intervention is collected from the at least one IoT device 120 and/or further forwarded to the analytics and learning server 150, as also described with reference to FIG. 1 and FIG. 2. In this way, the feedback may be analyzed by the analytics and learning server 150 for improving the entertainment experience.

FIG. 5 schematically shows an embodiment of an arrangement 500 which may be used in the IoT gateway 110 or any of the IoT devices 120 according to an embodiment of the present disclosure.

Comprised in the arrangement 500 are a processing unit 506, e.g., with a Digital Signal Processor (DSP). The processing unit 506 may be a single unit or a plurality of units to perform different actions of procedures described herein. The arrangement 500 may also comprise an input unit 502 for receiving signals from other entities, and an output unit 504 for providing signal(s) to other entities. The input unit 502 and the output unit 504 may be arranged as an integrated entity or as separate entities.

Furthermore, the arrangement 500 may comprise at least one computer program product 508 in the form of a non-volatile or volatile memory, e.g., an Electrically Erasable Programmable Read-Only Memory (EEPROM), a flash memory and/or a hard drive. The computer program product 508 comprises a computer program 510, which comprises code/computer readable instructions, which when executed by the processing unit 506 in the arrangement 500 causes the arrangement 500 and/or the IoT gateway 110 or the IoT devices 120 in which it is comprised to perform the actions, e.g., of the procedure described earlier in conjunction with FIGS. 1-4 or any other variant.

The computer program 510 may be configured as a computer program code structured in computer program modules 510A-510D. Hence, in an exemplifying embodiment when the arrangement 500 is used in the IoT gateway 110, the code in the computer program of the arrangement 500 includes: a first determination module 510A for determining a Special Effect (SFX) instruction from a media stream. The code in the computer program further includes a second determination module 510B for determining, according to the SFX instruction, at least one IoT device which is able to provide at least one special effect corresponding to the SFX instruction. The code in the computer program further includes a transmission module 510C for transmitting to the at least one IoT device an IoT device specific command corresponding to the SFX instruction. The code in the computer program may further include an optional feedback module 510D for collecting feedback comprising a command execution result and/or information about user intervention from the at least one IoT device and forward the same to a CDS.

Further, the computer program 510 may also be configured as a computer program code structured in computer program modules 510E-510F. Hence, in an exemplifying embodiment when the arrangement 500 is used in the IoT device 120, the code in the computer program of the arrangement 500 includes: a receiving module 510E for receiving an IoT device specific command corresponding to an SFX instruction which is determined from a media stream. The code in the computer program further includes an execution module 510F for executing the IoT device specific command to provide the SFX.

The computer program modules could essentially perform the actions of the flow illustrated in FIGS. 1-4, to emulate the IoT gateway 110 or the IoT devices 120. In other words, when the different computer program modules are executed in the processing unit 506, they may correspond to different modules in the IoT gateway 110 or the IoT devices 120.

Although the code means in the embodiments disclosed above in conjunction with FIG. 5 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1. A system for providing Special Effect (SFX) during a media stream, the system comprising:
a content delivery server adapted to
transmit the media stream comprising an SFX instruction;
an Internet of Things (IoT) gateway adapted to
monitor the media stream from the content delivery server,
determine the SFX instruction from the media stream,
determine, according to the SFX instruction, at least one IoT device that is able to provide at least one special effect corresponding to the SFX instruction, and
transmit to the at least one IoT device an IoT device specific command corresponding to the SFX instruction; and
the at least one IoT device adapted to
receive the IoT device specific command from the IoT gateway, and
provide the special effect according to the IoT device specific command.

2. A method, performed by an Internet of Things (IoT) gateway, for controlling at least one IoT device, the method comprising:
determining a Special Effect (SFX) instruction from a media stream;
determining, according to the SFX instruction, at least one IoT device that is able to provide at least one special effect corresponding to the SFX instruction; and
transmitting to the at least one IoT device an IoT device specific command corresponding to the SFX instruction.

3. The method according to claim 2, wherein the SFX instruction is coded into the media stream as a track, and wherein the determination of the SFX instruction comprises:
extracting the coded SFX instruction track from the media stream; and
decoding the SFX instruction from the coded SFX instruction track.

4. The method according to claim 2, wherein the SFX instruction is determined by an algorithm for determining control parameters from media content in the media stream.

5. The method according to claim 2, wherein the SFX instruction comprises at least one of: action, action parameter, time for action, duration of action, capability, and location.

6. The method according to claim 2, wherein the at least one IoT device is pre-registered in a registration list at the IoT gateway, and wherein the determination of at least one IoT device that is able to provide at least one special effect comprises:
searching, according to the SFX instruction, the registration list for the at least one IoT device that is able to provide at least one special effect corresponding to the SFX instruction.

7. The method according to claim 2, wherein the at least one IoT device comprises at least one of: a home appliance, a computer, and a haptic feedback device.

8. The method according to claim 7, wherein the home appliance comprises at least one of: a television, an audio system, an air conditioner, a heater, and a light.

9. The method according to claim 7, wherein the haptic feedback device comprises a haptic/actuated garment, an electronic bracelet, a furniture with haptic feedback capabilities.

10. The method according to claim 9, wherein the haptic/actuated garment comprises at least one of haptic/actuated gloves and shoes, and the furniture with haptic feedback capabilities comprises at least one of a chair and a sofa.

11. The method according to claim 2, wherein the transmission of the IoT device specific command comprises:
determining, based on the SFX instruction, the IoT device specific command from a translation table which is specific to the at least one IoT device; and
transmitting the IoT device specific command to the at least one IoT device.

12. The method according to claim 5, wherein the IoT device specific command is transmitted to the at least one IoT device by the IoT gateway in a way such that the action will be performed at the time for action.

13. The method according to claim 12, wherein the IoT device specific command is transmitted to the at least one IoT device by the IoT gateway before the time for action and the at least one IoT device will perform the action at the time for action.

14. The method according to claim 12, wherein the IoT device specific command is transmitted to the at least one IoT device by the IoT gateway at the time for action and the at least one IoT device will perform the action immediately.

15. The method according to claim 2, further comprising:
receiving from the at least one IoT device a command execution result in response to the IoT device specific command.

16. The method according to claim 2, further comprising:
receiving information about user intervention from the at least one IoT device.

17. The method according to claim 15, further comprising:
transmitting feedback comprising the command execution result to a content delivery server.

18. (canceled)

19. An electronic device for controlling at least one Internet of Things (IoT) device, the electronic device comprising:
a processor; and
a memory containing instructions which, when executed by the processor, causes the processor to:
determine a Special Effect (SFX) instruction from a media stream,
determine, according to the SFX instruction, at least one IoT device that is able to provide at least one special effect corresponding to the SFX instruction, and
transmit to the at least one IoT device an IoT device specific command corresponding to the SFX instruction.

20. A non-transitory computer-readable storage medium having instructions stored therein, which when executed by a processor, causes the processor (506) to perform operations by an Internet of Things (IoT), the operations comprising:
determining a Special Effect (SFX) instruction form a media stream;
determining, according to the SFX instruction, at least one IoT device that is able to provide at least one special effect corresponding to the SFX instruction; and
transmitting to the at least one IoT device an IoT device specific command corresponding to the SFX instruction.

21. (canceled)

22. (canceled)

23. A method, performed by an Internet of Things (IoT) device, for providing a Special Effect (SFX), the method comprising:
receiving an IoT device specific command corresponding to an SFX instruction that is determined from a media stream; and
executing the IoT device specific command to provide the SFX.

24. The method according to claim 23, wherein the IoT device is pre-registered in a registration list at an IoT gateway.

25. The method according to claim 23, further comprising:
transmitting to an IoT gateway a command execution result in response to the IoT device specific command.

26. The method according to claim 23, further comprising:
transmitting information about user intervention to an IoT gateway.

27. The method according to claim 23, wherein the IoT device maintains its SFX-related information comprising one or more of: device ID, device type, device location, resource availability, resource permission, and resource capability.

28. The method according to claim 27, further comprising:
reporting the SFX-related information to an IoT gateway.

29. (canceled)

30. An electronic device for providing a Special Effect (SFX), the electronic device comprising:
a processor; and
a memory containing instructions which, when executed by the processor, causes the processor to:
receive an Internet of Things (IoT) device specific command corresponding to an SFX instruction which is determined from a media stream; and
execute the IoT device specific command to provide the SFX.

31. A non-transitory computer-readable storage medium having instructions stored therein, which when executed by a processor, causes the processor to perform operations an Internet of Things (IoT) device for providing a Special Effect (SFX), the operations comprising:
receiving an IoT device specific command corresponding to an SFX instruction that is determined from a media stream; and
executing the IoT device specific command to provide the SFX.

32. (canceled)

33. (canceled)

34. The method according to claim 16, further comprising:
transmitting feedback comprising the information about user intervention to a content delivery server.
